(19) United States
(12) Patent Application Publication
(10) Pub. No.: US 2025/0151889 A1
(43) Pub. Date: May 15, 2025

(54) CLEANING BRUSH AND INTELLIGENT CLEANING DEVICE

(71) Applicant: Beijing Roborock Technology Co., Ltd., Beijing (CN)

(72) Inventors: Zhiwei ZHOU, Beijing (CN); Chong ZHOU, Beijing (CN); Bainian ZHAO, Beijing (CN)

(21) Appl. No.: 18/727,766

(22) PCT Filed: Aug. 23, 2022
(86) PCT No.: PCT/CN2022/114213

§ 371 Date: Jan. 20, 2025

(30) Foreign Application Priority Data
Jan. 10, 2022 (CN) 202220052838.5

(51) Int. Cl. A46B 13/00; A46B 13/02; A46D 3/00; A47L 9/04; A47L 11/40

(52) U.S. Cl. CPC A46B 13/005; A46B 13/02; A46D 3/00; A47L 9/0477; A47L 11/4041; A46B 2200/3033

(57) ABSTRACT

A cleaning brush and an intelligent cleaning device are provided. The cleaning brush includes: a shaft lever having two first end portions; an end portion member mounted on a first end portion, wherein the end portion member has a blocking structure for preventing entanglements from excessively extending away from the cleaning brush, the end portion member and the first end portion have mounting structures mutually matched; and the mounting structure includes a guide sleeve configured to be sleeved onto the first end portion; and a cylindrical member, coaxial with and sleeved onto the shaft lever, having two second end portions. A second end portion corresponding to the end portion member covers at least a portion of the guide sleeve of the corresponding end portion member.

### CROSS-REFERENCE TO RELATED APPLICATIONS

This application is a national phase application under 35 U.S.C. § 371 of International Application No. PCT/CN2022/114213, filed on Aug. 23, 2022, which is based on and claims priority to Chinese Patent Application No. 202220052838.5, filed on Jan. 10, 2022, both of which are incorporated by reference in their entireties herein.

### TECHNICAL FIELD

This application relates to the field of cleaning devices, and in particular, to a cleaning brush and an intelligent cleaning device.

### BACKGROUND

A cleaning brush is an important functional component of a cleaning device. End caps of the cleaning brush are used for blocking entanglements such as hair or silk threads that are wound around the cleaning device during a working process, so as to avoid the phenomenon that the entanglements extend excessively to end portions of the cleaning brush to be wound around a power output end and a bearing end of a motor so that the power output end and the bearing end of the motor are stuck.

### BRIEF SUMMARY

According to an aspect of this application, a cleaning brush is provided, wherein the cleaning brush includes a shaft lever, a cylindrical member and at least one end portion member; the shaft lever has two first end portions that are opposite in an axial direction, and at least one first limiting structure is arranged on a side wall of the first end portion; the cylindrical member is coaxial with and sleeved onto the shaft lever, and has two second end portions that are opposite in the axial direction, and a brush part is arranged on the outer surface of the cylindrical member; the at least one end portion member is mounted on at least one of the two first end portions, the end portion member has a blocking structure for preventing entanglements from excessively extending away from the cleaning brush, the end portion member and the first end portion have mounting structures respectively, the mounting structures being mutually matched, the mounting structure includes a guide sleeve arranged at one end of the end portion member facing the shaft lever, and configured to be sleeved onto the first end portion; and the second end portion of the cylindrical member corresponding to the end portion member covers at least a portion of the guide sleeve arranged at the one end of the corresponding end portion member facing the shaft lever.

According to another aspect of this application, an intelligent cleaning device is provided, wherein the intelligent cleaning device includes the cleaning brush proposed by this application and described in the above.

### BRIEF DESCRIPTION OF THE DRAWINGS

The various objectives, features and advantages of this application will become more apparent by considering the following detailed description of various embodiments of the present disclosure with reference to the accompanying drawings. The accompanying drawings are merely exemplary illustrations of the present disclosure and are not necessarily drawn to scale. In the accompanying drawings, the same reference numerals always indicate the same or similar components.

FIG. 1 shows a three-dimensional schematic structural diagram of a cleaning brush according to an exemplary embodiment.

FIG. 2 shows a three-dimensional exploded schematic diagram of the cleaning brush shown in FIG. 1.

FIG. 3 is a front view of FIG. 1.

FIG. 4 is a shaft-side section view of FIG. 3.

FIG. 5 is a front view of FIG. 2.

FIG. 6 is a shaft-side section view of FIG. 5.

FIG. 7 shows a three-dimensional schematic structural diagram of a shaft lever and end portion members of a cleaning brush shown in FIG. 1.

FIG. 8 is an enlarged exploded schematic diagram of part of the structure shown in FIG. 7.

FIG. 9 is an enlarged exploded schematic diagram of part of a structure of a cleaning brush according to an exemplary embodiment.

### DETAILED DESCRIPTION

Exemplary embodiments embodying the features and advantages of this application are described in detail in the following descriptions. It should be understood that the present disclosure may have various changes in different embodiments, which are all included within the scope of the present disclosure, and that the descriptions and accompanying drawings therein are intended to illustrate rather than limit this application.

In the following description of different exemplary implementations of the present application, reference is made to the accompanying drawings, which form part of the present disclosure, and in which different exemplary structures, systems, and steps that may implement aspects of the present application are shown by way of examples. It should be understood that other specific schemes of components, structures, exemplary devices, systems and steps may be used, and structural and functional modifications may be made without departing from the scope of the present disclosure. Moreover, although the terms “above”, “between”, “within” and the like may be used in this specification to describe different exemplary features and elements of the present application, these terms are used herein for convenience only, for example, according to the directions of the examples described in the accompanying drawings. Anything in this specification should not be construed as requiring a particular three-dimensional orientation of a structure to fall within the scope of the present disclosure.

End caps of an existing cleaning brush are small in size, longer end portions of a shaft lever of the cleaning brush are exposed outside the end caps, and the end caps are located outside a cylindrical member that sleeves the shaft lever of the cleaning brush, so that entanglements wound around the cylindrical member are easily wound from end portions of the cylindrical member to the end portions of the shaft lever to deeper positions, and the end caps have to be disassembled to take the entanglements out of the cylindrical member, wasting time and energy. Furthermore, since the end caps of the existing cleaning brush are small in size, an omission of the end caps is difficult to be found if it happens during an assembling process of the cleaning brush, and thus it is necessary to set up an additional omission prevention structure.

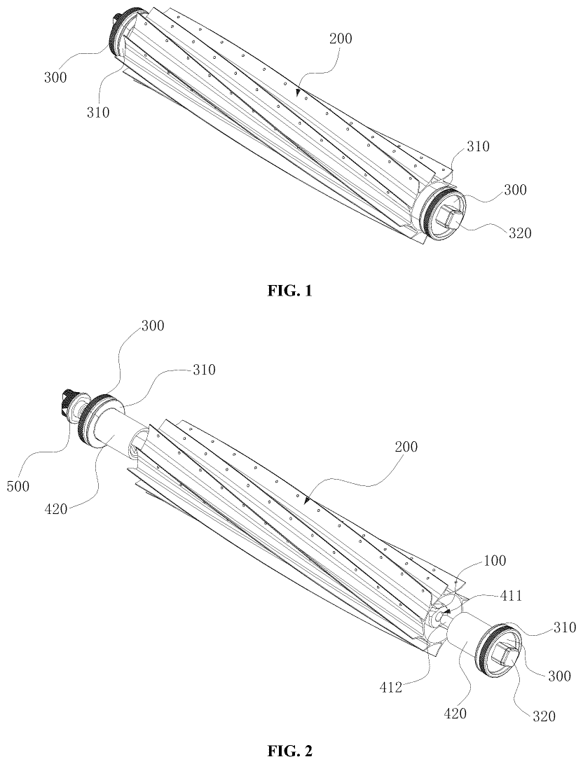

Referring to FIG. 1, which representatively shows a three-dimensional schematic structural diagram of a cleaning brush proposed by the present application. In this exemplary embodiment, the cleaning brush proposed by the present application is illustrated by taking application to an intelligent cleaning robot as an example. It is easy for those skilled in the art to understand that various modifications, additions, substitutions, deletions or other changes made to the following specific embodiments in order to apply relevant designs of the present application to other types of cleaning devices are still within the scope of the principle of the cleaning brush proposed by the present application.

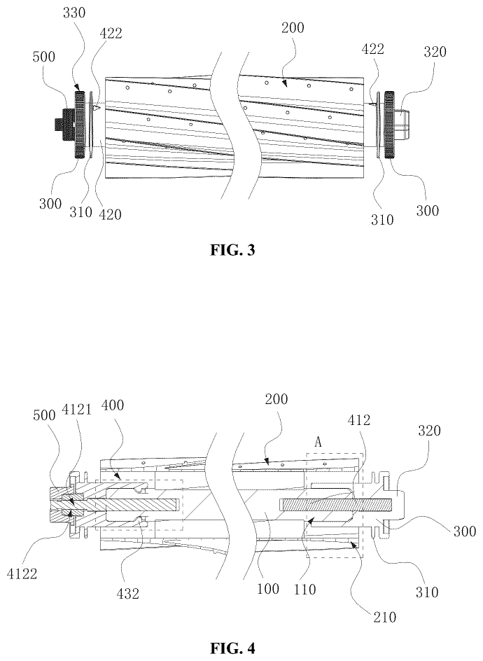

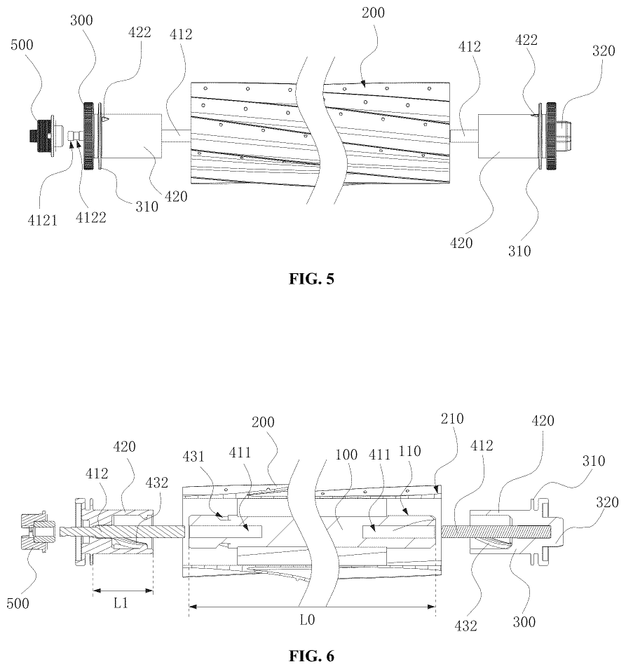

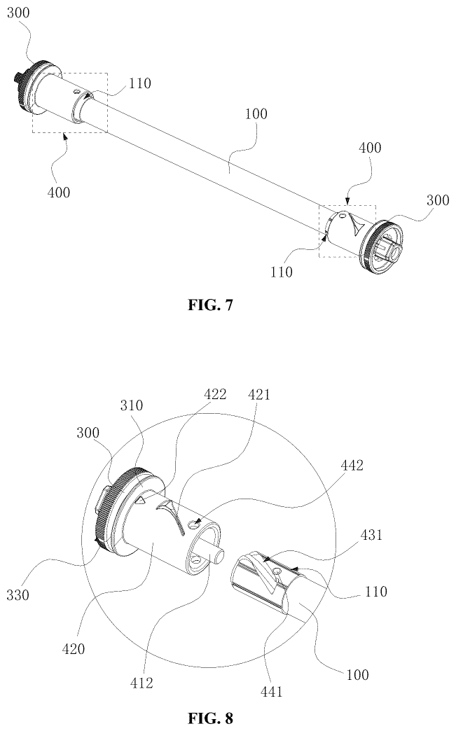

As shown in FIG. 1, in this embodiment, the cleaning brush proposed by the present application mainly includes a shaft lever (the shaft lever 100 shown in FIG. 2), the cylindrical member 200 and two end portion members 300. With reference to FIGS. 2-8, FIG. 2 representatively shows a three-dimensional exploded schematic diagram of the cleaning brush; FIG. 3 representatively shows a front view of FIG. 1; FIG. 4 representatively shows a shaft-side section view of FIG. 3; FIG. 5 representatively shows a front view of FIG. 2; FIG. 6 representatively shows a shaft-side section view of FIG. 5; FIG. 7 representatively shows a three-dimensional schematic structural diagram of the shaft lever 100 and the end portion members 300; and FIG. 8 representatively shows an enlarged exploded schematic diagram of part of the structure shown in FIG. 7, which specifically shows an exploded state of one end portion member 300 and one first end portion 110 of the shaft lever. Structures, connection ways and functional relationships of main components of the cleaning brush proposed by the present application are described in detail hereinafter with reference to the accompanying drawings.

As shown in FIGS. 1-4, in an embodiment of the present application, the shaft lever 100 has two first end portions 110 that are opposite in an axial direction, that is, two ends of the shaft lever 100 are the first end portions 110 respectively. The cylindrical member 200 is sleeved onto the shaft lever 100 coaxially; and the cylindrical member 200 has two second end portions 210 that are opposite in an axial direction, that is, two ends of the cylindrical member 200 are the second end portions 210 respectively. A brush part is arranged on the outer surface of the cylindrical member 200. The two end portion members 300 are mounted at the two first end portions 110 of the shaft lever 100 respectively. Each end portion member 300 has a blocking structure 310. The blocking structure 310 may prevent entanglements such as hair or silk threads from excessively extending away from the cleaning brush. Moreover, the end portion member 300 and the corresponding first end portion 110 respectively have mutually matched mounting structures 400. The mounting structure 400 includes a guide sleeve 420 arranged at one end of the end portion member 300 facing the shaft lever 100, and the guide sleeve 420 may be sleeved onto the first end portion 110 of the shaft lever 100 corresponding to the end portion member 300. On this basis, the second end portion 210 of the cylindrical member 200 corresponding to the end portion member 300 covers at least a portion of the guide sleeve. For details, reference may be made to a coverage area A shown in FIG. 4. Through the above design, the present application allows at least a portion of the guide sleeve 420 to intervene between the shaft lever 100 and the corresponding end portion of the cylindrical member 200 to make entanglements wound around the cylindrical member 200 be mainly wound around the guide sleeve 420 rather than being directly wound around the shaft lever 100, so that the entanglements can be removed along with the disassembly of the end portion member 300, and cleaning is more convenient. Furthermore, during an assembling process of the cleaning brush, when the end portion members 300 are not assembled, component missing of the cleaning brush is apparent and is easier to be found.

It should be noted that the embodiments in this specification are illustrated respectively with each of the two first end portions 110 of the shaft lever 100 being provided with the end portion member 300 as an example. It should be understood that the present application may also allow the end portion member 300 to be mounted on only one first end portion 110 of the shaft lever 100 in some embodiments. In other words, in various possible embodiments that conform to the design conception of the present application, the cleaning brush proposed by the present application includes at least one end portion member 300, and the at least one end member 300 is mounted on at least one first end portion 110 of the shaft lever 100.

As shown in FIGS. 2, 4 and 6, in an embodiment of the present application, the second end portion 210 of the cylindrical member 200 corresponding to the end portion member 300 may cover the first end portion 110 on which the corresponding end portion member 300 is mounted. In other words, the first end portion 110, on which the end portion member 300 is mounted, is entirely disposed within the coverage of the second end portion 210 corresponding to the first end portion 110, that is, the first end portion 110 do not stretch out of the second end portion 210, that is, the shaft lever 100 is shorter than the cylindrical member 200. In some embodiments, the first end portion 110, on which the end portion member 300 is mounted, may also partially stretch out of the coverage of the corresponding second end portion 210, that is, the first end portion 110 may stretch out of the coverage area A shown in FIG. 4. Thus, the configuration of the first end portion is not limited to this embodiment, and it is only needed to ensure that the second end portion 210 covers at least a portion of the end portion member 300.

As shown in FIGS. 1-6. in an embodiment of the present application, the blocking structure 310 of the end portion member 300 may be disposed outside the second end portion 210 of the cylindrical member 200 corresponding to the end portion member 300. In other words, the blocking structure 310 of the end portion member 300 may be disposed outside the coverage area A shown in FIG. 4.

As shown in FIGS. 2, 4 and 6, in an embodiment of the present application, the mounting structure 400 may include a guide hole 411 and a guide shaft 412. Specifically, the guide hole 411 is coaxial with the first end portion 110 and is formed in an end face of the first end portion 110. The guide shaft 412 is connected with the end portion member 300, and used to be inserted in the guide hole 411. Through the above design, the present application may provide an axial guiding function and a radial limiting function in the mounting of the end portion member 300 and the shaft lever 100 by using the guide shaft 412 and the guide hole 411, which are in plug-in fit with each other.

As shown in FIGS. 1-6, in an embodiment of the present application, the mounting structures 400 may also include a guide sleeve 420. Specifically, the guide sleeve 420 is arranged at one end of the end portion member 300 facing the shaft lever 100 and may be sleeved onto the first end portion 110. On this basis, a first limiting structure is arranged on a side wall of the first end portion, and a second limiting structure matched with the first limiting structure is arranged on an inner wall of the guide sleeve 420. Accordingly, the cleaning brush may avoid relative rotation between the shaft lever 100 and the end portion member 300 through the matching of the first limiting structure and the second limiting structure.

Furthermore, as shown in FIGS. 2, 4 and 6, in an embodiment of the present application, the mounting structure 400 may include the guide hole 411, the guide shaft 412 and the guide sleeve 420 at the same time. On this basis, the guide sleeve 420 may be arranged around at least partial sections of the guide shaft 412 with one or more gaps. In some embodiments, the mounting structure 400 may only include the guide hole 411 and the guide shaft 412, or may only include the guide sleeve 420. The mounting and fixing of the end portion member 300 and the first end portion 110 of the shaft lever 100 may be achieved through other structures.

As shown in FIG. 6, according to an embodiment of the present application, in the axial direction of the shaft lever 100, a distance L1 between one end of the guide sleeve 420 far away from a main body and the blocking structure 310 corresponding to the same first end portion 110 as the guide sleeve 420 may be greater than 5% (for example, 5%, 8%, 10%, 15%, etc.) of a length L0 of the shaft lever 100. Accordingly, compared with the design that the end caps of the existing cleaning brush are smaller in size, the design in the present application that the guide sleeve 420 partially intervenes between the first end portion 110 and the second end portion 210 can make the end portion member 300 has a larger size (including the size of the guide sleeve 420), so as to enlarge the space of the end portion member 300 for winding of the entanglements, and further prevent the entanglements from winding around the shaft lever 100. In other words, the present application adopts the design of the length relationship of the above related members, so that the part of the end portion member 300 matched with the shaft lever 100 is prolonged, the size is increased, and the processing and production are easy.

As shown in FIGS. 6 and 8, in an embodiment of the present application, the first limiting structure may be a limiting groove 431, and the second limiting structure may be a limiting rib 432, and the limiting groove 431 is matched with the limiting rib 432 in shape. Accordingly, in a process of sleeving the first end portion 110 of the shaft lever 100 with the guide sleeve 420, the limiting rib 432 is matched with the limiting groove 431 and may provide guiding and limiting functions in the above mounting process. In some embodiments, the first limiting structure may also be the limiting rib 432, and the second limiting structure may also be the limiting groove 431. In other words, in various possible embodiments that conform to the design conception of the present application, one of the first limiting structure and the second limiting structure may be the limiting rib 432, while the other may be the limiting groove 431 matched with the limiting rib 432 in shape. Furthermore, the first limiting structure and the second limiting structure may also adopt limiting fit structures in other forms, and are not limited to the above embodiments.

As shown in FIGS. 6 and 8, in an embodiment of the present application, the limiting rib 432 and the limiting groove 431 may have matched spiral shapes. Accordingly, the end portion member 300 and the shaft lever 100 are relatively displaced in the axial direction and relatively rotated in the circumferential direction during dismounting and mounting of the end portion member 300 and the shaft lever 100.

Based on the design that the limiting rib 432 and the limiting groove 431 have spiral shapes, in an embodiment of the present application, the spiral directions of the spiral limiting rib 432 and the spiral limiting groove 431 may be opposite to the rotation direction of the shaft lever 100. Through the above design, since the spiral directions of the limiting rib 432 and the limiting groove 431 are opposite to the rotation direction of the shaft lever 100, when the shaft lever 100 rotates in the cleaning device in the rotation direction, looseness of the limiting rib 432 and the limiting groove 431 may be further avoided to ensure the mounting stability and reliability of the shaft lever 100 and the end portion member 300.

As shown in FIGS. 7 and 8, based on the design that the limiting rib 432 and the limiting groove 431 have spiral shapes, in an embodiment of the present application, the outer wall of the guide sleeve 420 may be provided with at least one first assembly mark 421. The first assembly mark 421 may mark the rotation direction of the end portion member 300 when assembling with the shaft lever 100 (i.e., the spiral directions of the limiting rib 432 and the limiting groove 431).

As shown in FIGS. 7 and 8, based on the design that the guide sleeve 420 is provided with the first assembly mark 421, in an embodiment of the present application, the outer wall of the guide sleeve 420 may be provided with a deformation groove; and the deformation groove may prevent shrinkage deformation of injection molded parts such as the guide sleeve 420 and the end portion member 300. Based on this, the deformation groove may take a special shape (approximately a triangle shape or arrowhead shape, for example) to serve as the first assembly mark 421, so as to mark the rotation direction of the end portion member 300 when assembling with the shaft lever 100 while preventing shrinkage deformation.

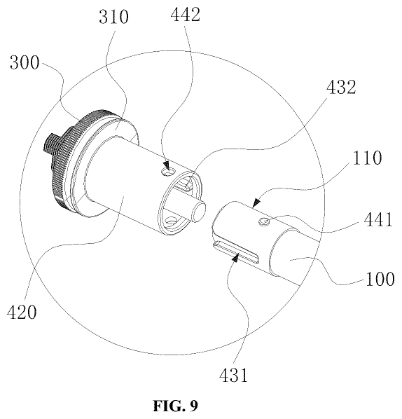

Reference is made to FIG. 9, which representatively shows an enlarged exploded schematic diagram of part of the structure of a cleaning brush proposed by the present application according to another embodiment, and specifically shows an exploded state of one end portion member 300 and one first end portion 110 of the shaft lever.

As shown in FIG. 9, in an embodiment of the present application, one of the first limiting structure and the second limiting structure may be the limiting rib 432, while the other may be the limiting groove 431. Based on this, the limiting rib 432 and the limiting groove 431 may have linear shapes matched with each other.

As shown in FIGS. 4 and 6, in an embodiment of the present application, when the second limiting structure is the limiting rib 432, the limiting rib 432 may be arranged on the inner wall of the guide sleeve 420 by an integral forming process. In some embodiments, the limiting rib 432 may also be arranged on the inner wall of the guide sleeve 420 by other processes, for example, by welding, or by stamping a partial structure of the guide sleeve 420. Furthermore, when the second limiting structure is the limiting groove 431, the limiting groove 431 may be a groove formed in the inner wall of the guide sleeve 420 or a through groove penetrating through the guide sleeve 420.

In an embodiment of the present application, the first end portion 110 may be provided with a plurality of first limiting structures, which are arranged uniformly at intervals in the circumferential direction of the shaft lever 100.

In an embodiment of the present application, the guide sleeve 420 may be provided with a plurality of second limiting structures, which are arranged uniformly at intervals in the circumferential direction of the guide sleeve 420.

As described above, with the first limiting structure and the second limiting structure being the limiting groove 431 and the limiting rib 432 respectively as an example, there may be one or more limiting ribs 432 in case of a plurality of limiting grooves 431, and the number of the limiting ribs 432 is not greater than but may be less than that of the limiting grooves 431.

As shown in FIGS. 7 and 8, in an embodiment of the present application, a third limiting structure may be arranged on the side wall of the first end portion 110, and a fourth limiting structure matched with the third limiting structure may be arranged on the inner wall of the guide sleeve 420. Based on this, one of the third limiting structure and the fourth limiting structure may be a bump fastener 441, while the other may be a fastening groove 442 in fastening fit with the bump fastener 441. Through the above design, the present application can provide a good feel in disassembly and assembly and a function of judging whether the assembly is in place through the fastening of the bump fastener 441 and the fastening groove 442, simplify the difficulty of disassembly and assembly, provide a certain fool-proofing effect, and further improve the user experience.

In an embodiment of the present application, the first end portion 110 of the shaft lever 100 may be provided with a plurality of first limiting structures and a plurality of third limiting structures, of which the numbers may be equal. Based on this, the plurality of first limiting structures and the plurality of third limiting structures may be arranged alternately in sequence at intervals in the circumferential direction of the shaft lever 100.

Based on the design that the first end portion 110 of the shaft lever 100 is provided with the plurality of first limiting structures and the plurality of third limiting structures, of which the numbers are equal, in an embodiment of the present application, the plurality of first limiting structures and the plurality of third limiting structures may be arranged uniformly at intervals in the circumferential direction of the shaft lever 100. Through the above design, the present application can make the limiting structures be stressed more uniformly during a process that the end portion member 300 transmits torque to the shaft lever 100.

In an embodiment of the present application, the guide sleeve 420 may be provided with a plurality of second limiting structures and a plurality of fourth limiting structures, of which the numbers may be equal. Based on this, the plurality of second limiting structures and the plurality of fourth limiting structures may be arranged alternately in sequence at intervals in the circumferential direction of the shaft lever 100.

Based on the design that the guide sleeve 420 is provided with the plurality of second limiting structures and the plurality of fourth limiting structures, of which the numbers are equal, in an embodiment of the present application, the plurality of second limiting structures and the plurality of fourth limiting structures may be arranged uniformly at intervals in the circumferential direction of the shaft lever 100. Through the above design, the present application can make the limiting structures be stressed more uniformly during the process that the end portion member 300 transmits torque to the shaft lever 100.

As shown in FIG. 8, in an embodiment of the present application, when the fourth limiting structure is the bump fastener 441, the bump fastener 441 may be arranged on the inner wall of the guide sleeve 420 by an integral forming process. In some embodiments, the bump fastener 441 may also be arranged on the inner wall of the guide sleeve 420 by other processes, for example, by welding, or by stamping a partial structure of the guide sleeve 420. Furthermore, when the fourth limiting structure is the limiting groove 442, the limiting groove 442 may be a groove formed in the inner wall of the guide sleeve 420 or a through groove penetrating through the guide sleeve 420.

As shown in FIGS. 5 and 8, in an embodiment of the present application, at least one second assembly mark 422 may be arranged on the outer wall of the guide sleeve 420; and the position of the at least one second assembly mark 422 may correspond to that of at least one second limiting structure to mark the position of the at least one second limiting structure. In some embodiments, when a plurality of second limiting structures are arranged on the inner wall of the guide sleeve 420, only one second assembly mark 422 corresponding to any second limiting structure may be arranged on the outer wall of the guide sleeve 420, or a plurality of second assembly marks 422 corresponding to the second limiting structures respectively may be arranged on the outer wall of the guide sleeve 420.

As shown in FIGS. 1-6, in an embodiment of the present application, the blocking structure 310 of the end portion member 300 may be a blocking ring, and the blocking ring may surround the end portion member 300 and forms a closed-ring structure.

As shown in FIGS. 1-7, in an embodiment of the present application, both first end portions 110 of the shaft lever 100 are provided with the end portion members 300. Based on this, one of the two end portion members 300 is provided with the transmission structure 320 which is used for transmitting torque, and the other of the two end portion members 300 is used for mounting the bearing structure 500. Based on this, the end portion member 300 provided with the transmission structure 320 is used to be connected with a driving mechanism of the cleaning device through the transmission structure 320, and the end portion member 300 provided with the bearing structure 500 is used to be connected rotatably with other structures (for example, a machine body) of the cleaning device through the bearing structure 500. Accordingly, when the end portion member 300 (i.e., a driving-side end cap) provided with the transmission structure 320 is mounted, the driving-side end cap rotates around the guide hole 411, and the driving-side end cap may move in the axial direction while rotating due to the spiral limiting groove 431 and the spiral limiting rib 432, so as to complete the assembly and disassembly of the entire end cap. Similarly, when the end portion member 300 (i.e., a bearing-side end cap) for mounting the bearing structure 500 is mounted, the bearing-side end cap can be mounted and dismounted according to the same movement logic. Meanwhile, since the spiral directions of the spiral limiting rib 432 and the spiral limiting groove 431 are opposite to the rotation direction (i.e., an operation direction of a main brush) of the shaft lever 100, spiral loosening is avoided during operation. Through the above design, during an assembling process of the cleaning brush, when the end portion members 300 are not assembled, matching structures (such as a laminated structure and the bearing structure 500) mounted or arranged on the two end portion members 300 are not arranged, so that main brush parts (such as the shaft lever 100 and the cylindrical member 200) cannot be assembled in place when the end portion members 300 are omitted, and accordingly a more complete omission prevention function can be achieved. Furthermore, when both first end portions 110 of the shaft lever 100 are provided with the end portion members 300, the same mounting structures 400 are adopted between the two first end portions 110 of the shaft lever 100 and the two end portion members 300, which facilitates error prevention during production, is beneficial to reducing the error rate of processing, and increases the production yield.

As shown in FIGS. 1 and 2, based on the design that one end portion member 300 is provided with the transmission structure 320, in an embodiment of the present application, the transmission structure 320 may include a columnar structure with a regular polygonal cross section, the axis of the columnar structure coincides with those of the end portion member 300 and the shaft lever 100, and accordingly the transmission structure 320 may be used to be matched with an output end of a driving mechanism, for example, a final output gear of a gearbox.

As shown in FIGS. 2 and 6, based on the design that the other end portion member 300 is provided with the bearing structure 500, in an embodiment of the present application, one end of the guide shaft 412 of the end portion member 300 facing away from the shaft lever 100 stretches out of the end portion member 300 to serve as a matching section 4121 matched with the bearing structure 500; and the bearing structure 500 is detachably arranged on the matching section 4121 of the guide shaft 412.

As shown in FIGS. 5 and 6, based on the design that the guide shaft 412 has the matching section 4121, in an embodiment of the present application, the matching section 4121 of the guide shaft 412 may be provided with a positioning groove 4122 in a circumferential direction, for example, the outer diameter of the matching section 4121 is designed to be smaller than those of other sections of the guide shaft 412 to make the matching section 4121 form the positioning groove 4122. Based on this, the positioning groove 4122 is in positioning fit with the bearing structure 500 to prevent displacement of the bearing structure 500.

As shown in FIGS. 8 and 9, in an embodiment of the present application, the end portion member 300 may be provided with a friction structure 330, such as, but not limited to, friction patterns, friction protrusions, etc., which makes the end portion member 300 be easier to be screwed in the assembling process.

In an embodiment of the present application, the cylindrical member 200 may be a flexible member or a rigid member. Furthermore, the brush part may be arranged on the outer surface of the cylindrical member 200 by bonding, inserting or the like. When the cylindrical member 200 is the flexible member, the brush part may also be integrally formed with the cylindrical member 200. In some embodiments, the brush part may also be in other forms, for example, in the form of blades or bristles.

It should be noted here that the cleaning brush shown in the accompanying drawings and described in this specification are only a few examples of a number of kinds of cleaning brushes that may apply the principles of the present application. It should be clearly understood that the principles of the present application are not limited to any detail or any component of the cleaning brush shown in the accompanying drawings or described in this specification.

### EXAMPLES

In an embodiment of the present application, the limiting rib and the limiting groove may be matched in shape, and each of the limiting rib and the limiting groove may have a linear shape or a spiral shape.

In an embodiment of the present application, the second limiting structure is the limiting rib; and the limiting rib is arranged on the inner wall of the guide sleeve by a welding or integral forming process, or is formed by a partial structure of the guide sleeve by a stamping process. Alternatively, the second limiting structure is the limiting groove, and the limiting groove is a groove formed in the inner wall of the guide sleeve or a through groove penetrating through the guide sleeve.

In an embodiment of the present application, the first end portion is provided with a plurality of first limiting structures, and the plurality of first limiting structures are arranged uniformly at intervals in the circumferential direction of the shaft lever.

In an embodiment of the present application, the guide sleeve is provided with a plurality of second limiting structures, and the plurality of second limiting structures are arranged uniformly at intervals in the circumferential direction of the guide sleeve.

In an embodiment of the present application, the first end portion is provided with a plurality of first limiting structures and a plurality of third limiting structures, of which the numbers are equal, wherein the plurality of first limiting structures and the plurality of third limiting structures are arranged alternately in sequence at intervals in the circumferential direction of the shaft lever.

In an embodiment of the present application, the plurality of first limiting structures and the plurality of third limiting structures are arranged uniformly at intervals in the circumferential direction of the shaft lever.

In an embodiment of the present application, the guide sleeve is provided with a plurality of second limiting structures and a plurality of fourth limiting structures, of which the numbers are equal, wherein the plurality of second limiting structures and the plurality of fourth limiting structures are arranged alternately in sequence at intervals in the circumferential direction of the guide sleeve.

In an embodiment of the present application, the plurality of second limiting structures and the plurality of fourth limiting structures are arranged uniformly at intervals in the circumferential direction of the guide sleeve.

In an embodiment of the present application. the fourth limiting structure is a bump fastener; and the bump fastener is arranged on the inner wall of the guide sleeve by a welding or integral forming process, or is formed by a partial structure of the guide sleeve by a stamping process. Alternatively, the fourth limiting structure is a fastening groove, and the fastening groove is a groove formed in the inner wall of the guide sleeve or a through groove penetrating through the guide sleeve.

In an embodiment of the present application, the transmission structure includes a columnar structure with a regular polygonal cross section, the axis of the columnar structure coincides with those of the end portion member and the shaft lever, and the transmission structure is used to be matched with an output end of a driving mechanism.

In an embodiment of the present application, one end of the guide shaft of one end portion member facing away from the shaft lever stretches out of the end portion member to serve as a matching section matched with the bearing structure; and the bearing structure is detachably arranged on the matching section of the guide shaft.

In an embodiment of the present application, a positioning groove is formed in the matching section in a circumferential direction; the positioning groove is in positioning fit with the bearing structure to prevent displacement of the bearing structure.

In an embodiment of the present application, the cylindrical member may be a flexible member or a rigid member.

Based on the above detailed description of the exemplary embodiments of the cleaning brush proposed by the present application, an exemplary embodiment of the intelligent cleaning device proposed by the present application will be described below.

In an embodiment of the present application, the intelligent cleaning device proposed by the present application includes the cleaning brush proposed by the present application and described in the above embodiments.

It should be noted here that the intelligent cleaning device shown in the accompanying drawings and described in this specification are only a few examples of a number of kinds of intelligent cleaning devices that may apply the principles of the present application. It should be clearly understood that the principles of the present application are not limited to any detail or any component of the intelligent cleaning device shown in the accompanying drawings or described in this specification.

In conclusion, the cleaning brush proposed by the present application includes the shaft lever 100, the cylindrical member 200 and the end portion member 300. The end portion member 300 is mounted at the first end portion 110 of the shaft lever 100 and has the blocking structure 310 used to prevent the entanglements from excessively extending away from the cleaning brush. The end portion member 300 and the first end portion 110 have mutually matched mounting structures 400 respectively. The mounting structure 400 includes the guide sleeve 420 arranged at one end of the end portion member 300 facing the shaft lever 100. The guide sleeve 420 is used to be sleeved onto the first end portion 110 of the shaft lever 100. The second end portion 210 of the cylindrical member 200 corresponding to the end portion member 300 covers at least a portion of the guide sleeve 420. Through the above design, the present application allows at least a portion of the guide sleeve 420 to intervene between the shaft lever 100 and the corresponding end portion of the cylindrical member 200 to make the entanglements wound around the cylindrical member 200 be wound around the guide sleeve 420 rather than being directly wound around the shaft lever 100, so that the entanglements can be removed along with the disassembly of the end portion member 300, and cleaning is more convenient.

According to an aspect of this application, a cleaning brush is provided, wherein the cleaning brush includes a shaft lever, a cylindrical member and at least one end portion member; the shaft lever has two first end portions that are opposite in an axial direction, and at least one first limiting structure is arranged on a side wall of the first end portion; the cylindrical member is coaxial with and sleeved onto the shaft lever, and has two second end portions that are opposite in the axial direction, and a brush part is arranged on the outer surface of the cylindrical member, the at least one end portion member is mounted on at least one of the two first end portions, the end portion member has a blocking structure for preventing entanglements from excessively extending away from the cleaning brush, the end portion member and the first end portion have mounting structures respectively, the mounting structures being mutually matched, the mounting structure includes a guide sleeve arranged at one end of the end portion member facing the shaft lever, and configured to be sleeved onto the first end portion; and the second end portion of the cylindrical member corresponding to the end portion member covers at least a portion of the guide sleeve arranged at the one end of the corresponding end portion member facing the shaft lever.

According to an embodiment of this application, the second end portion of the cylindrical member corresponding to the end portion member covers the first end portion on which the corresponding end portion member is mounted.

According to an embodiment of the present disclosure, the blocking structure of the end portion member is disposed outside the second end portion of the cylindrical member corresponding to the end portion member.

According to an embodiment of this application, the mounting structure further includes a guide hole and a guide shaft; the guide hole is coaxial with the first end portion and formed in an end face of the first end portion; and the guide shaft is connected to the end portion member, and the guide shaft is used to be inserted in the guide hole.

According to an embodiment of this application, in the axial direction of the shaft lever, a distance between one end of the guide sleeve far away from a main body and the blocking structure is greater than 5% of the length of the shaft lever, the guide sleeve and the blocking structure corresponding to a same first end portion.

According to an embodiment of this application, the at least one first limiting structure is arranged on the side wall of the first end portion, and at least one second limiting structure matched with the at least one first limiting structure is arranged on an inner wall of the guide sleeve, wherein one of the first limiting structure and the second limiting structure is a limiting rib, and the other one of the first limiting structure and the second limiting structure is a limiting groove; and the limiting rib is matched with the limiting groove in shape.

According to an embodiment of this application, at least one third limiting structure is arranged on the side wall of the first end portion, and at least one fourth limiting structure matched with the at least one third limiting structure is arranged on the inner wall of the guide sleeve, wherein one of the third limiting structure and the fourth limiting structure is a bump fastener, and the other one of the third limiting structure and the fourth limiting structure is a fastening groove in fastening fit with the bump fastener.

According to an embodiment of this application, the limiting rib and the limiting groove are matched in shape, and each of the limiting rib and the limiting groove has a linear shape or a spiral shape.

According to an embodiment of this application, the second limiting structure is the limiting rib; and the limiting rib is arranged on the inner wall of the guide sleeve by a welding or integral forming process, or is formed by a partial structure of the guide sleeve by a stamping process. Alternatively, the second limiting structure is the limiting groove, and the limiting groove is a groove formed in the inner wall of the guide sleeve or a through groove penetrating through the guide sleeve.

According to an embodiment of this application, the first end portion is provided with a plurality of first limiting structures arranged uniformly at intervals in a circumferential direction of the shaft lever.

According to an embodiment of this application, the guide sleeve is provided with a plurality of second limiting structures arranged uniformly at intervals in a circumferential direction of the guide sleeve.

According to an embodiment of this application, the end portion member and the guide sleeve are integrally formed.

According to an embodiment of this application, the first end portion is provided with a plurality of first limiting structures and a plurality of third limiting structures, of which the numbers are equal, wherein the plurality of first limiting structures and the plurality of third limiting structures are arranged alternately in sequence at intervals in the circumferential direction of the shaft lever.

According to an embodiment of this application, the plurality of first limiting structures and the plurality of third limiting structures are arranged uniformly at intervals in the circumferential direction of the shaft lever.

According to an embodiment of this application, the guide sleeve is provided with a plurality of second limiting structures and a plurality of fourth limiting structures, of which the numbers are equal, wherein the plurality of second limiting structures and the plurality of fourth limiting structures are arranged alternately in sequence at intervals in the circumferential direction of the guide sleeve.

According to an embodiment of this application, the plurality of second limiting structures and the plurality of fourth limiting structures are arranged uniformly at intervals in the circumferential direction of the guide sleeve.

According to an embodiment of this application, the fourth limiting structure is a bump fastener; and the bump fastener is arranged on the inner wall of the guide sleeve by a welding or integral forming process, or is formed by a partial structure of the guide sleeve by a stamping process. Alternatively, the fourth limiting structure is a fastening groove, and the fastening groove is a groove formed in the inner wall of the guide sleeve or a through groove penetrating through the guide sleeve.

According to an embodiment of this application, at least one second assembly mark is arranged on an outer wall of the guide sleeve; and a position of the at least one second assembly mark corresponds to a position of the at least one second limiting structure to mark the position of the at least one second limiting structure.

According to an embodiment of this application, the blocking structure is a blocking ring, and the blocking ring surrounds the end portion member and forms a closed-ring structure.

According to an embodiment of this application, each of the two first end portions of the shaft lever is mounted with the end portion member; and one of the two end portion members is provided with a transmission structure, and the other one of the two end portion members is configured for mounting a bearing structure.

According to an embodiment of this application, the transmission structure includes a columnar structure with a regular polygonal cross section, an axis of the columnar structure coincides with axis of the end portion member and the shaft lever, and the transmission structure is used to be matched with an output end of a driving mechanism.

According to an embodiment of this application, one end of the guide shaft of one end portion member facing away from the shaft lever stretches out of the end portion member to serve as a matching section matched with the bearing structure; and the bearing structure is detachably arranged on the matching section of the guide shaft.

According to an embodiment of this application, a positioning groove is formed in the matching section in a circumferential direction; the positioning groove is in positioning fit with the bearing structure to prevent displacement of the bearing structure.

According to an embodiment of this application, the cylindrical member is a flexible member or a rigid member.

According to another aspect of this application. an intelligent cleaning device is provided, wherein the intelligent cleaning device includes the cleaning brush proposed by this application and described in the above embodiments.

The exemplary embodiments of the cleaning brush and intelligent cleaning device proposed by the present application are described and/or illustrated above in detail. However, the embodiments of the present application are not limited to the specific embodiments described herein. On the contrary, the components and/or steps of each embodiment can be used independently and separately from the other components and/or steps described herein. Each component and/or step of one embodiment can also be used in conjunction with other components and/or steps of other embodiments. In the description of elements, components and the like described and/or illustrated herein, the terms “one”, “a/an” and “above” are used to indicate the existence of one or more elements, components and the like. The terms “include/comprise”, “including/comprising” and “have/has” are used to mean open-ended inclusion and mean that there may be other elements, components and the like in addition to those listed. Furthermore, the terms “first” and “second” in the claims and the specification are used only as marks and are not numerical restrictions on their objects.

Although the cleaning brush and intelligent cleaning device proposed by the present application are described according to different specific embodiments, those skilled in the art will recognize that modifications can be made to implementations of the present application within the scope of the claims.

1. A cleaning brush, comprising:
a shaft lever having two first end portions that are opposite in an axial direction, wherein at least one limiting structure is arranged on a side wall of the first end portion;
at least one end portion member mounted on at least one of the two first end portions, wherein the end portion member has a blocking structure for preventing entanglements from excessively extending away from the cleaning brush; the end portion member and the first end portion have mounting structures respectively, the mounting structures being mutually matched; and the mounting structure comprises a guide sleeve arranged at one end of the end portion member facing the shaft lever, and configured to be sleeved onto the first end portion; and
a cylindrical member coaxial with and sleeved onto the shaft lever, wherein the cylindrical member has two second end portions that are opposite in the axial direction; and a brush part is arranged on an outer surface of the cylindrical member;
wherein the second end portion of the cylindrical member corresponding to the end portion member covers at least a portion of the guide sleeve arranged at the one end of the corresponding end portion member facing the shaft lever.

2. The cleaning brush according to claim 1, wherein the second end portion of the cylindrical member corresponding to the end portion member covers the first end portion on which the corresponding end portion member is mounted.

3. The cleaning brush according to claim 1, wherein the blocking structure of the end portion member is disposed outside the second end portion of the cylindrical member corresponding to the end portion member.

4. The cleaning brush according to claim 1, wherein the mounting structure further comprises:
a guide hole coaxial with the first end portion, formed in an end face of the first end portion; and
a guide shaft connected with the end portion member and configured to be inserted in the guide hole.

5. The cleaning brush according to claim 1, wherein in the axial direction of the shaft lever, a distance, between the blocking structure and one end of the guide sleeve far away from the blocking structure, is greater than 5% of a length of the shaft lever, the guide sleeve and the blocking structure corresponding to a same first end portion.

6. The cleaning brush according to claim 1, wherein the end portion member and the guide sleeve are integrally formed.

7. The cleaning brush according to claim 1, wherein at least one of:
at least one first limiting structure is arranged on the side wall of the first end portion, and at least one second limiting structure matched with the at least one first limiting structure is arranged on an inner wall of the guide sleeve, wherein one of the first limiting structure and the second limiting structure is a limiting rib, and the other one of the first limiting structure and the second limiting structure is a limiting groove, the limiting rib being matched with the limiting groove in shape; and
at least one third limiting structure is arranged on the side wall of the first end portion, at least one fourth limiting structure matched with the at least one third limiting structure is arranged on the inner wall of the guide sleeve, wherein one of the third limiting structure and the fourth limiting structure is a bump fastener, and the other one of the third limiting structure and the fourth limiting structure is a fastening groove in fastening fit with the bump fastener.

8. The cleaning brush according to claim 7, wherein at least one assembly mark is arranged on an outer wall of the guide sleeve; and a position of the at least one assembly mark corresponds to a position of the at least one second limiting structure to mark the position of the at least one second limiting structure.

9. The cleaning brush according to claim 1, wherein the blocking structure is a blocking ring, and the blocking ring surrounds the end portion member and forms a closed-ring structure.

10. The cleaning brush according to claim 1, wherein each of the two first end portions of the shaft lever is mounted with the end portion member; and one of the two end portion members is provided with a transmission structure, and the other one of the two end portion members is configured for mounting a bearing structure.

11. The cleaning brush according to claim 7, wherein the limiting rib and the limiting groove are matched in shape, and each of the limiting rib and the limiting groove has a linear shape or a spiral shape.

12. The cleaning brush according to claim 7, wherein at least one of:
the second limiting structure is one of the limiting rib, arranged on the inner wall of the guide sleeve by a welding or integral forming process, or formed by a partial structure of the guide sleeve by a stamping process; or the limiting groove, being a groove formed in the inner wall of the guide sleeve, or a through groove penetrating through the guide sleeve, and
the fourth limiting structure is one of: a bump fastener, arranged on the inner wall of the guide sleeve by a welding or integral forming process, or formed by a partial structure of the guide sleeve by a stamping process; or a fastening groove, being a groove formed in the inner wall of the guide sleeve, or a through groove penetrating through the guide sleeve.

13. The cleaning brush according to claim 1, wherein at least one of:
the first end portion is provided with a plurality of the first limiting structures arranged uniformly at intervals in a circumferential direction of the shaft lever, and
the guide sleeve is provided with a plurality of second limiting structures arranged uniformly at intervals in a circumferential direction of the guide sleeve.

14. (canceled)

15. The cleaning brush according to claim 7, wherein at least one of:
the first end portion is provided with a plurality of the first limiting structures and a plurality of the third limiting structures, of which the numbers are equal; and the plurality of first limiting structures and the plurality of third limiting structures are arranged alternately in sequence at intervals in a circumferential direction of the shaft lever; and
the guide sleeve is provided with a plurality of the second limiting structures and a plurality of the fourth limiting structures, of which the numbers are equal; and the plurality of second limiting structures and the plurality of fourth limiting structures are arranged alternately in sequence at intervals in a circumferential direction of the guide sleeve.

16. The cleaning brush according to claim 15, wherein the plurality of first limiting structures and the plurality of third limiting structures are arranged uniformly at intervals in the circumferential direction of the shaft lever.

17-19. (canceled)

20. The cleaning brush according to claim 10, wherein the transmission structure comprises a columnar structure with a regular polygonal cross section, an axis of the columnar structure coincides with axis of the end portion member and the shaft lever, and the transmission structure is configured to be matched with an output end of a driving mechanism.

21. The cleaning brush according to claim 10, wherein one end, facing away from the shaft lever, of the guide shaft of one end portion member stretches out of the end portion member to serve as a matching section matched with the bearing structure; and the bearing structure is detachably arranged on the matching section of the guide shaft.

22. The cleaning brush according to claim 21, wherein a positioning groove is formed in the matching section in a circumferential direction; and the positioning groove is in positioning fit with the bearing structure to prevent displacement of the bearing structure.

23. The cleaning brush according to claim 1, wherein the cylindrical member is a flexible member or a rigid member.

24. An intelligent cleaning device, wherein the intelligent cleaning device comprises a cleaning brush comprising:
a shaft lever having two first end portions that are opposite in an axial direction, wherein at least one limiting structure is arranged on a side wall of the first end portion,
at least one end portion member mounted on at least one of the two first end portions, wherein the end portion member has a blocking structure for preventing entanglements from excessively extending away from the cleaning brush; the end portion member and the first end portion have mounting structures respectively, the mounting structures being mutually matched; and the mounting structure comprises a guide sleeve arranged at one end of the end portion member facing the shaft lever, and configured to be sleeved onto the first end portion; and
a cylindrical member coaxial with and sleeved onto the shaft lever, wherein the cylindrical member has two second end portions that are opposite in be axial direction, and a brush part is arranged on an outer surface of the cylindrical member;
wherein the second end portion of the cylindrical member corresponding to the end portion member covers at least a portion of the guide sleeve arranged at the one end of the corresponding end portion member facing the shaft lever.
